(19) United States
(12) Patent Application Publication
(10) Pub. No.: US 2023/0041422 A1
(43) Pub. Date: Feb. 9, 2023

(54) Method and System for Facilitating Virtual Gifting

(71) Applicant: Philip Berta, Monroe Township, NJ (US)

(72) Inventor: Philip Berta, Monroe Township, NJ (US)

(21) Appl. No.: 17/533,253

(22) Filed: Nov. 23, 2021

Related U.S. Application Data
(60) Provisional application No. 63/228,783, filed on Aug. 3, 2021.

(51) Int. Cl. G06Q 30/06; G06Q 20/36; G06Q 20/22

(52) U.S. Cl. CPC G06Q 30/0631; G06Q 20/363; G06Q 20/223; G06Q 30/0633

(57) ABSTRACT

The present invention relates to a method, system, and computer program product for facilitating sharing of desired items stored in a digital wallet for gifting purposes. The invention includes selection of items by users to be saved in their digital wallets and sharing of the wallet and items saved therein with other users such as friends, relatives and others. The other users can view the content of the shared wallets and can purchase one or more items for gifting. The invention also includes registration of the sellers for listing items for sale at a discounted price, along with a percentage sharing with the server used in the digital wallet.

### CROSS-REFERENCE TO RELATED APPLICATION

The present application claims priority to, and the benefit of, U.S. Provisional Application No. 63/228,783, which was filed on Aug. 3^{rd}, 2021 and is incorporated herein by reference in its entirety.

### FIELD OF THE INVENTION

The present invention relates generally to the field of digital wallets. More specifically, the present invention relates to a gifting wallet software application that is used in a digital gifting system and a method for facilitating sharing of digital wallets among users for purchasing desired items or for gifts. The invention includes a virtual wallet that enables a user to place the desired items within the wallet, such that the wallet and the items saved therein can be viewed by others who wish to gift the items within the wallet to the user. Sellers can register on the system and sell products via the application for discounted prices. The invention offers a way for individuals to gift other individuals items that they are interested in and have stored in their wallets. Accordingly, the present disclosure makes specific reference thereto. Nonetheless, it is to be appreciated that aspects of the present invention are also equally applicable to other like applications, devices and methods of manufacture.

### BACKGROUND

Traditionally, individuals have been giving physical gifts on occasions such as birthdays, anniversaries and other occasions. It has been generally observed that individuals may end up purchasing the same or similar gifts, which can lead to duplicate gifts for the recipient as well. Further, while gifting a clothing item or any other wearable item, the sizes may be wrong which can be frustrating for both the buyer and recipient of the gift items. Individuals may end up either returning the gift item or not using the gift at all. Similar issues can result with respect to colors and other choices related to clothing items and other personal preferences.

Further, the disadvantages of such physical gifts are that the users must physically carry the gift, after receiving it, which can be difficult for individuals, especially when size of the gift is large. Nowadays, individuals have started giving physical gift cards, but even these physical cards have to be physically transferred and the recipient present while making a purchase, and if the card is lost, a replacement is generally unavailable.

Generally, with the advent of electronic commerce, individuals have started sharing digital gift cards, however they lack the personalization of buying desired gifts for others. Sharing of gift cards lacks the true value of gifting items to others and merely represents a transfer of money. Individuals may not know whether the gift card was used for purchasing a gift or not. The recipient may not be able to share the items that are liked or desired.

Therefore, there exists a long felt need in the art for a system and method that enables users to gift items that are liked and desired by a recipient. There is also a long felt need in the art for a system and method that enables users to purchase gifts themselves for others. Additionally, there is a long felt need in the art for a system and method that enables users to order the gifts virtually. Moreover, there is a long felt need in the art for a system and method that enables the users to purchase gifts that eliminates the physical carrying of the gift items. Further, there is a long felt need in the art for a system and method that also enables sellers to sell gift items digitally. Finally, there is a long felt need in the art for a system and method that offers a way for individuals to gift other people items that the recipients are interested in, rather than speculating or guessing.

The subject matter disclosed and claimed herein, in one embodiment thereof, comprises a method for providing a virtual gifting wallet to users. The method comprises: receiving by a server of a gifting system, a selection of one or more items from a list of items arranged on a gifting software application wherein the selected one or more items includes pricing information; receiving by the server of the gifting system, a request for saving the list, or particulars, of one or more items in a virtual gifting wallet associated with the user who has made the request; thereafter, receiving by the server, a sharing request to share the virtual gifting wallet and one or more items stored in the wallet with one or more other users; and, finally receiving by the server, a purchase request to purchase one or more items stored in the virtual gifting wallet for gifting to the user with whom the wallet is associated. The method also includes tagging an occasion and a date with one or more items stored in the wallet.

In this manner, the method and system of the present invention accomplishes all of the forgoing objectives, and provides a relatively easy, convenient and efficient solution for individuals to gift items of interest to the recipients. The method and system of the present invention enables individuals to share their desired items with others, and those other individuals can then purchase the desired items when convenient. The invention also enables others connected to the user's profile to view items in the wallet for potential and future gift purchases.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a method for providing a virtual gifting wallet to users. The method comprises: receiving by a server of a gifting system, a selection of one or more items from a list of items listed on a gifting software application wherein the selected one or more items includes descriptions and pricing information; receiving by the server of the gifting system, a request for saving the list and particulars of one or items in a virtual gifting wallet associated with the user who has made the request; thereafter, receiving by the server, a sharing request to share the virtual gifting wallet and one or more items stored in the wallet with one or more other users; and, finally receiving by the server, a purchase request to purchase one or more items stored in the virtual gifting wallet for gifting to the user with whom the wallet is associated. The method also includes tagging an occasion and a date with one or more items stored in the wallet.

In yet another embodiment of the present invention, a method includes receiving by the server, a profile creation request wherein the request includes name, gender, age, product preferences, store preferences and other such type of information, and recommending by a recommendation engine a list of items to the user based on the profile of the user.

In yet another embodiment, the method further includes determining if one or more items stored in the wallet are purchased by a user, from a plurality of users, with whom the wallet and the contents were shared and in case the one or more items are purchased, then notifying the user associated with the wallet and other users with whom the wallet was shared that the one or more items have been purchased.

In yet another embodiment of the present invention, the method includes comparing the profile characteristics of the user with features of products listed and then displaying a subset of items for selecting and saving in virtual gifting wallet.

In yet another embodiment of the present invention, a computer-implemented method of sharing a list of selected items with other users for gifting, wherein the items are selected in a software application stored on a computer storage medium is disclosed. The method comprises: receiving selections from a user of one or more items from a list of items displayed by the software application; storing requests from the user of the selected one or more items in a virtual gifting wallet; receiving wallet sharing requests by the user for sharing the wallet and one or more stored items with one or more users; and receiving purchase requests of the one or more items from the one or more users.

In yet another embodiment of the present invention, a virtual gifting platform is disclosed. The virtual gifting platform is designed to allow users to share items stored in a virtual gifting wallet with other users for gifting purposes. The platform includes a server that includes a recommendation engine, a user profile database and at least one product storage server. The recommendation engine can be used for recommending items to users based on the profile characteristics stored in the user profile database, and product listings stored in the product storage server. The server can be in communication with a computer-implemented gifting software application installed in an electronic device through a computer network such as the Internet. The software application enables users to store items in a virtual gifting wallet and share the wallet with other users, thereby enabling the other users to purchase items for gifting purposes.

In yet another embodiment, sellers can offer items listed on the application at a discounted price and split a percentage of sale value with the gifting platform.

In yet another embodiment, a non-transitory computer-usable medium having computer readable code embodied therein is included. The computer-readable code comprises computer code for causing at least one processor to execute instructions stored in at least one memory to receive registration information of a user for profile creation, receive selection of one or more items, share a wallet having stored selected items with other users and calculate a percentage of sale value of selected items.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of a virtual gift wallet system using a virtual gift wallet software application of the present invention in accordance with the disclosed architecture;

FIG. 2 illustrates a block diagram showing how the gift wallet software application of the present invention displays desired gift items to the users for adding to the gift wallet in accordance with the disclosed architecture;

FIG. 3 illustrates a flow diagram showing exemplary steps performed for adding gift items to the virtual gift wallet of the gift wallet software application of the present invention in accordance with the disclosed architecture;

FIG. 4 illustrates a flow diagram showing exemplary steps performed for gifting items stored in a user's gift wallet software application of the present invention in accordance with the disclosed architecture;

FIG. 5 illustrates a schematic view showing how a seller version of gift wallet application of the present invention is used for selling gift items in accordance with the disclosed architecture;

FIG. 6 illustrates a flow diagram showing exemplary steps performed by a seller for selling items on the gifting application of the present invention in accordance with the disclosed architecture;

FIG. 7 illustrates an exemplary user interface 700 of the gift wallet application 104 of the present invention showing different options to a user in accordance with the disclosed architecture; and

FIG. 8 illustrates an exemplary electronic device 102 in which the gifting application 104 of the present disclosure is installed in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a system and method that enables users to gift items that are liked and desired by a recipient. There is also a long felt need in the art for a system and method that enables users to purchase gifts themselves for others. Additionally, there is a long felt need in the art for a system and method that enables users to order the gifts virtually. Moreover, there is a long felt need in the art for a system and method that enables the users to purchase gifts that eliminates the physical carrying of the gift items. Further, there is a long felt need in the art for a system and method that also enables sellers to sell gift items digitally. Finally, there is a long felt need in the art for a system and method that offers a way for individuals to gift other people items that they are interested in rather than speculating or guessing.

The present invention, in one exemplary embodiment, includes a virtual gifting platform. The virtual gifting platform can be designed to allow users to share items stored in a virtual gifting wallet with other users for gifting purposes. The platform includes a server that includes a recommendation engine, a user profile database, and at least one product storage server. The recommendation engine can be used for recommending items to users based on the profile characteristics stored in the user profile database and product listings stored in the product storage server. The server is in communication with a computer-implemented gifting software application installed in an electronic device through a network such as the Internet. The software application enables users to store items in a virtual gifting wallet and share the wallet with other users, thereby enabling the other users to purchase items for gifting purposes.

Embodiments of the present disclosure take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured or constructed to perform one or more of the computer-executable algorithms described below. Accordingly, the term “computer” as generally used herein, refers to any data processor and includes Internet appliances, hand-held devices (including tablets, computers, wearable computers, cellular or mobile phones, multi-processor systems, processor-based or programmable consumer electronics, network computers, minicomputers) and the like.

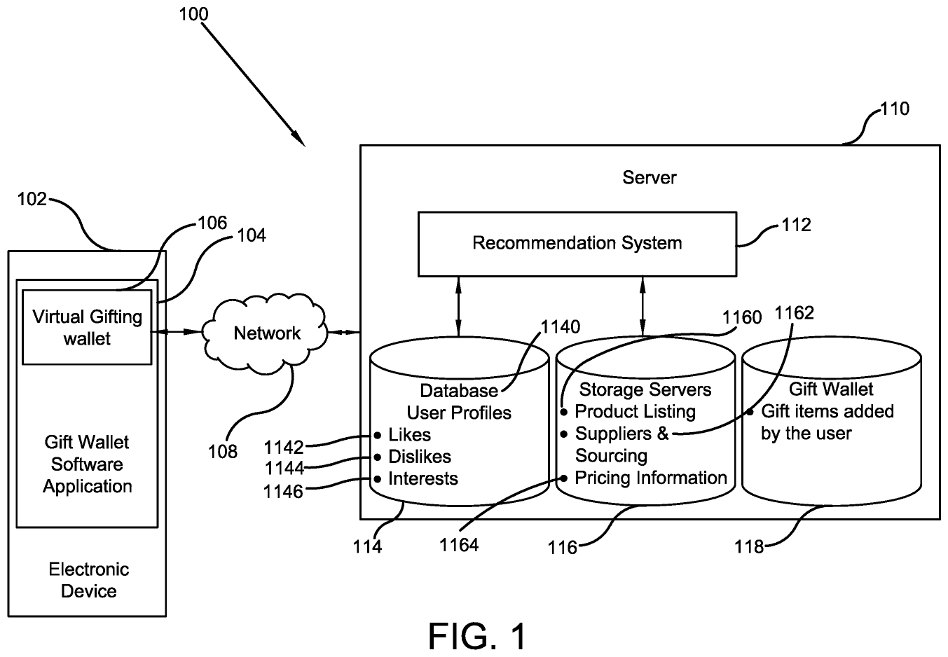

Referring initially to the drawings, FIG. 1 illustrates a schematic view of a virtual gift wallet system using a virtual gift wallet software application of the present invention in accordance with the disclosed architecture. The virtual gift wallet system/platform 100 is based on a virtual gifting wallet software application 104 that features a virtual and digital gifting wallet 106. The gifting wallet 106 enables a user to add desired gift items in the digital wallet 106 and the added items can be viewed by other users such as friends, relatives or family members who wish to gift the items to the user who added the items into the gifting wallet 106. The gift wallet software application 104 enables other users to purchase gift items for carrying out the gifting process. Additionally, the gifting wallet application 104 enables other individuals to gift money in the gifting wallet 106 of other users, such that a user in whose gifting wallet 106 the money is gifted/deposited can purchase the desired gift items on his or her own. The software wallet application 104 is configured to be installed in an electronic device 102 such as smartphone. The application 104 uses controls of the electronic device 102 for executing steps performed by a user on the application 104.

In the gifting system 100, the wallet software application 104 is in communication with a server 110 over a network 108 such as the Internet. The server 110 is associated with the software application 104 and the communication between the application 104 and the server 110 can be encrypted and secure using any known encryption technique such as Secure Sockets Layer (SSL). Information, particulars and contents saved in the virtual wallet 106 of the user include payment information, profile information and other similar information which can be transferred in an encrypted manner. Generally, users register on the software application 104 and create a profile and provide their details such as interests, likes, dislikes, personality, and other such preferences for obtaining desired gift item recommendations based on the user profile. The server 110 includes a user profile database 114 that stores user profile information. The user profile database 114 can automatically link and sync the user's profile information (i.e. phone number contact information) upon registration. The server 110 also includes a storage server 116 that can store data such as product listing, suppliers and sourcing, pricing information and other such types of product-related information. Specifically, the software application 104 enables the sellers to list their products at a discounted price. For revenue generation, the system 100 can retain a predefined percentage fee or commission of the sale amount. Additionally, the sellers may be charged a registration fee to list their products on the software application 104.

The server 110 includes a recommendation engine 112 which uses the information stored in user profile database 114 and the storage server 116 for providing recommendations to the users for selecting items to store in their virtual gifting wallet 106. The recommendation engine 112 evaluates the product listing 1160, ranking of suppliers 1162, pricing information 1164 or any other such type of information stored in the storage server 116 with the information stored in the user profile database 114, for recommending an inventory of products from pre-determined retailers/sellers. The recommendation engine 112 can evaluate the information stored in user profiles 1140 that includes likes 1142, dislikes 1144 and interests 1146 of the users to and recommend the product listing. The recommendation engine 112 collectively analyses the data related to the user profile 114 and the storage server 116, and recommends relevant results based on a filtering mechanism such as the collaborative filtering.

The software application 104 enables the user, after receiving the desired gift items, to select one or more items and add the selected desired gift items into the virtual gifting wallet 106. Once the user has selected the desired gift items to be added within the wallet 104, the server 110 adds the desired gift item in the gift wallet database 118 and associates the gift items to the virtual gifting wallet of the user. The gift wallet application 104 then displays the desired gift items that are added and present in the virtual gifting wallet 106 to the user and other associated users as explained later in the disclosure.

It should be appreciated that the software application 104 provides an e-commerce experience of selecting gift items from a list of items displayed on the application. The application 104, through the gifting wallet 106, provides a gifting platform to the users for gifting items to others where the items are already chosen by the individuals who want to receive gifts.

In particular, various embodiments of the invention discussed herein are implemented using the Internet as a means of communicating among a plurality of computer systems. One skilled in the art will recognize that the present invention is not limited to the use of the Internet as a communication medium, and that alternative methods of the invention may accommodate the use of a private intranet, a Local Area Network (LAN), a Wide Area Network (WAN) or other means of communication. In addition, various combinations of wired, wireless (e.g., radio frequency) and optical communication links can be utilized.

Electronic devices within the scope of the present disclosures include exemplary devices such as a mobile telephone, smartphone, tablet, personal digital assistant, laptop, iPod®, iPad®, BLACKBERRY® device, etc.

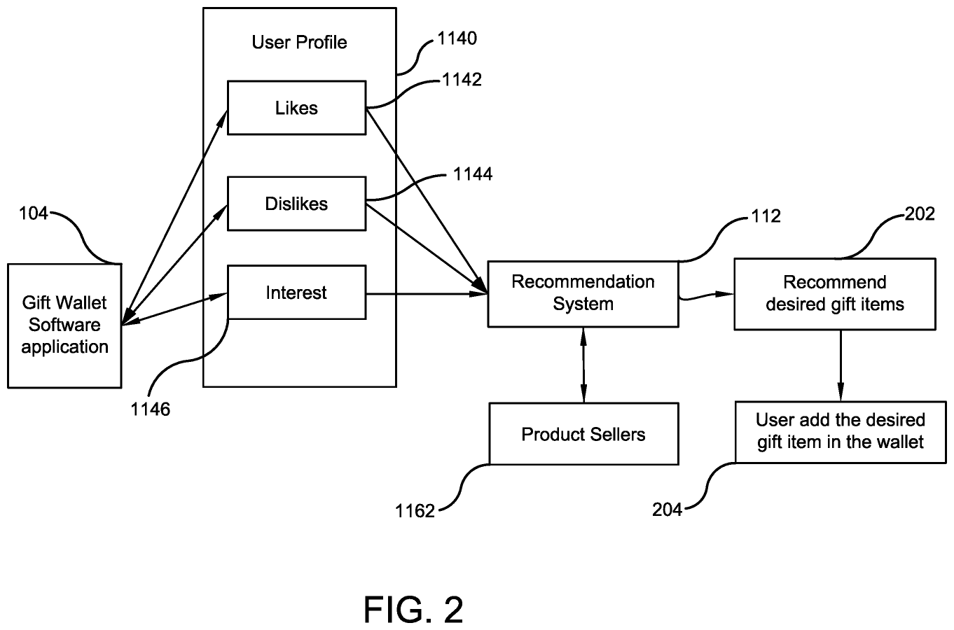

FIG. 2 illustrates a block diagram showing how the gift wallet software application of the present invention displays desired gift items to the users for adding to the gift wallet in accordance with the disclosed architecture. As shown in FIG. 2, the gift wallet software application 104 based on a user profile 1140 provides the desired gift items 202 from a plurality of product sellers 1162. The user profile 1140 can be designed based on various parameters or by answering questions from a preset database of questions. These parameters or questions can be based on, but not limited to, the user's likes 1142, dislikes 1144, interests 1146 or any other such type of parameter. The like parameter 1142 can ask the user to provide information related to types of colors a user likes, types of clothes a user likes, and other preferences. The interest parameter 1146 can ask the user to provide information related to their favorite games, hobbies, gift types and other such types of information. Other parameters can include the user's gender, age, product preferences, store preferences and other such types of information. Further, as the user keeps interacting with the application 104, the user's profile keeps updating.

Once the user profile is built and is stored in the server, the recommendation system 112 recommends relevant desired items 202 for the user to add to the virtual gifting wallet 204.

The gift wallet software application 104 enables the product suppliers 1162 to register themselves and sell products via the application 104 in at discounted prices. The product suppliers 1162 who sell their products via the gift wallet software application 104 may have to pay a percentage fee of their sale to the application 104, thereby creating a business model for revenue generation. Once the desired gift items are recommended to the user, the users can add the desired gift items in the wallet and can share the details of the wallet and the stored items with their friends, relatives and others who are willing to purchase gift items for the user. The advantage of the virtual gifting wallet 106 of the software application 104 is that a user can store the items or money that are desired, and the other users who want to gift the user can gift those desired items or money by purchasing through the application 104. The application 104 eliminates the scenarios where individuals gift something that is not desired, liked nor needed by the recipient of the gift. The application 104 includes a computer utility that can be used by individuals of all ages to store gift items, share gift items with others and buy gifts for others.

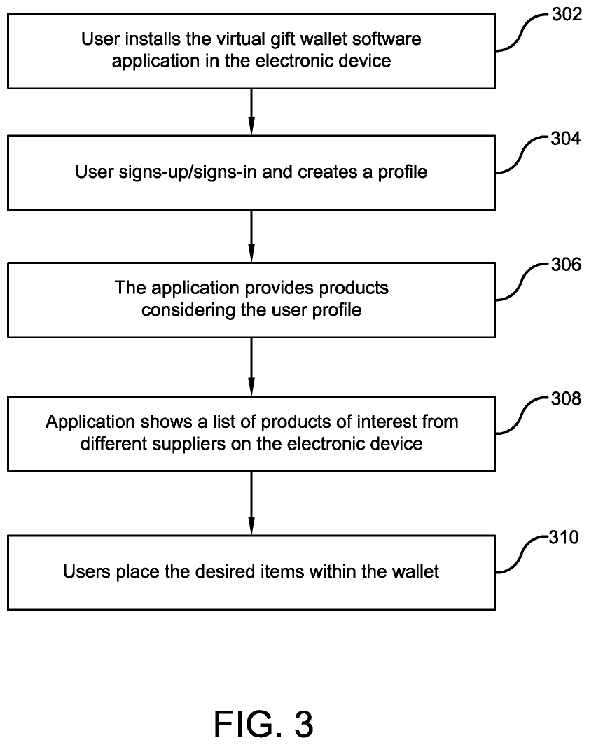

FIG. 3 illustrates a flow diagram showing exemplary steps performed for adding gift items to the virtual gift wallet of the gift wallet software application of the present invention in accordance with the disclosed architecture. Initially, a user installs the gift wallet software application in an electronic device such as smartphone, laptop, mobile device or any other such type of device (Block 302). The software application can be downloaded from a playstore and is available for all conventional operating systems such as Android, iOS and others. Then, the user signs-up and creates a profile by providing interests, likes, dislikes, etc., in the software application using input controls of the electronic device. If the profile is already created, the user can directly sign-in by providing a username and a password to access the desired gift items (Block 304). During the sign-up process, the user can set up his or her profile using his or her name and general information which is encrypted and protected on a secure server. The general information can include first name, age, sex and other such type of demographic information. Once the sign-up process is completed, the user can build a profile using AI technology based on his or her likes, dislikes, favorite gift types, etc. The gift wallet software application considers the user profile and selects recommended gift items based on the user profile (Block 306). Then, the software application can display the list of the recommended gift items on the display of the electronic device (Block 308). It should be noted that various filters based on cost, item types, color, seller and others can be provided by the application for enabling the users to narrow down the list of displayed products. Finally, the users can place the desired gift items within the wallet from the variety of pre-determined vendors or sellers that matches the user's profile (Block 310).

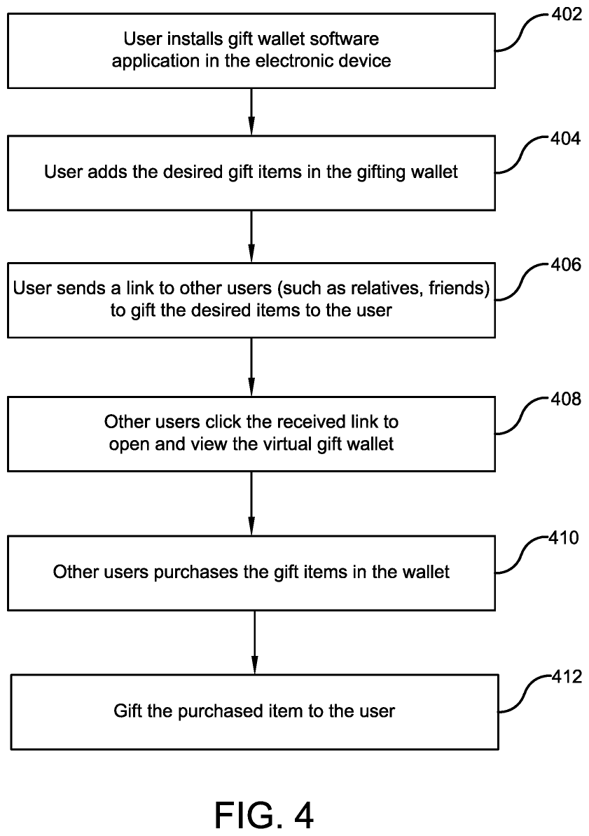

FIG. 4 illustrates a flow diagram showing exemplary steps performed for gifting items stored in a user's gift wallet software application of the present invention in accordance with the disclosed architecture. As shown in FIG. 4, initially a user installs the gift wallet software application having the virtual gifting wallet in an electronic device such as a smartphone, a laptop, a mobile device or any other such type of device (Block 402). Once the user profile is created, the user adds the desired gift items into the wallet (Block 404). Then, for sharing the items stored in the gifting wallet, the user can share a link such as an URL address with other users such as friends, relatives or family members for gifting the desired items stored in the wallet of the user (Block 406). Other users such as relatives and friends can click the received link to view the items and associated details stored in the wallet before gifting (Block 408). One of the many stored items in the virtual wallet can be shared with other users and also a single item can be shared with multiple users. For sharing the items, the user can select the users from a contact list or can send the link through an email from within the application or through a separate email application. The sharing of the items can also be done using a sharing feature of the application, where the other users having the application installed in their devices can receive the in-application notification. In one embodiment, using the link, the other users can sign-up on the gift wallet application and build their profiles by providing general information such as name, age, etc.

Relatives, friends, or any other users can purchase the desired gift items that are added by the user in the wallet by paying the cost of the item (Block 410). Further, the friends or relatives gift the items of interest to the user (Block 412). The purchased item can be delivered to the address of the user or can be delivered to any other address. The user, upon receiving the gifts (i.e. items of interest) can post photos and comments to the wallet of the user. When a stored item in the virtual wallet of the user is purchased by another user, the user is notified that an item is purchased along with the details of the purchaser. In such cases, where the same item was shared with multiple persons, the other users are also notified that the shared item has been purchased by another user, thereby eliminating a duplicate purchase of the same gift item. Additionally, the gift wallet application also enables relatives or friends to gift money in the form of a gift card to the user, which enables the user to purchase the desired gift item on his or her own.

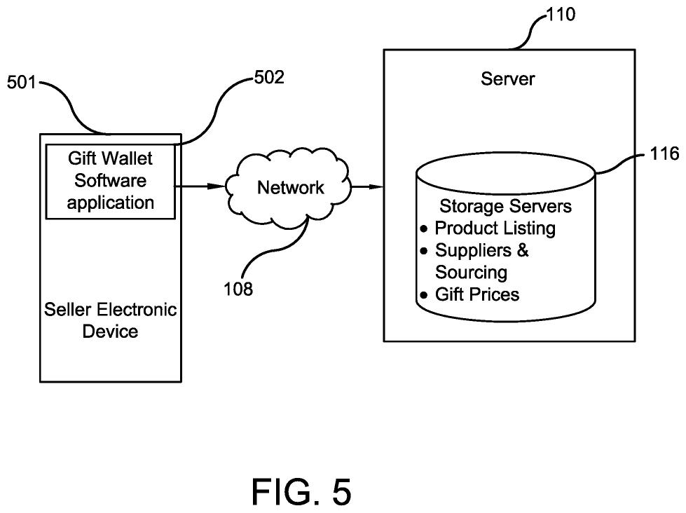

FIG. 5 illustrates a schematic view showing how a seller version of gift wallet application of the present invention can be used for selling gift items in accordance with the disclosed architecture. For registering on the gifting system of the present invention and for listing and selling items on the software application, a seller installs the seller variant of the gift wallet software application 502 in an electronic device 501 associated with the seller. The seller gift wallet application 502 is in communication with the server 110 over the network 108. The product sellers can be individual sellers or companies such as Amazon, Target or any other private retailer or vendor that can collaborate with the software application and gift platform of the present invention. The server 110 receives the data related to the gift items such as product listing, product prices and other such types of product information from the seller gift wallet software application 502 over the network 108.

The server 110, after receiving the product information over the network, stores the product information such as product listing, suppliers and sourcing, pricing information and other such types of product information in the storage server 116. The storage server 116 can comprise a processer to execute instructions, send and receive data and perform other operations to implement the operations and functions described herein associated with processes as shown in the figures and discussed throughout the disclosure. The software application associated with the user retrieves the product information from the storage server 116 and displays the desired items so that the user can add items into the gift wallet and the seller can sell the desired items. It should be appreciated that the seller gift wallet software application 502 enables sellers to upload and sell the gift items at discounted prices.

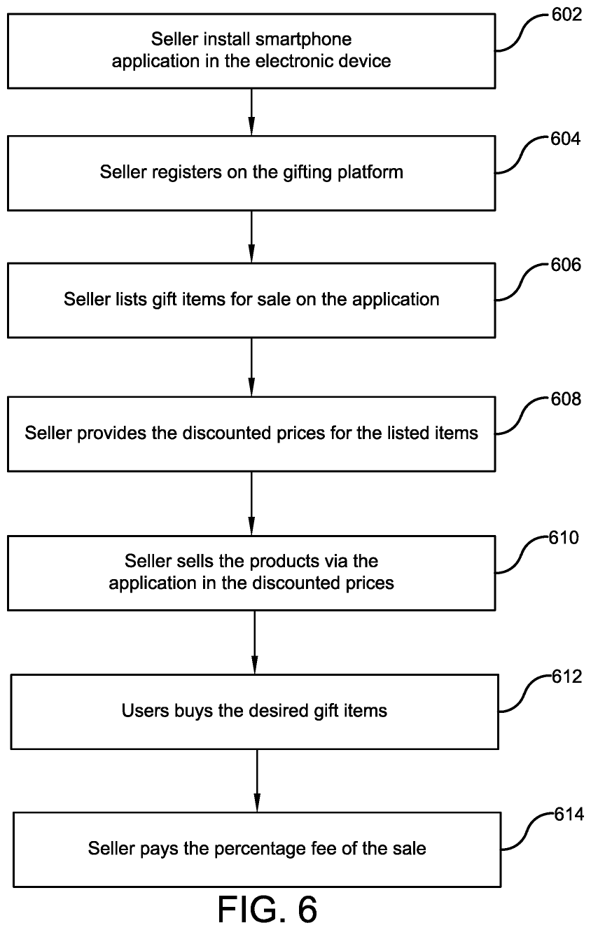

FIG. 6 illustrates a flow diagram showing exemplary steps performed by a seller for selling items on the gifting application of the present invention in accordance with the disclosed architecture. As shown in FIG. 6, the seller installs the seller gift wallet smartphone application in the electronic devices such as a smartphone or a mobile phone (Block 602). Alternatively, the seller can access the gifting platform through a web browser. Then, the seller registers by providing general information which is encrypted and protected on a secure server. If a profile is already created, the seller can directly sign-in by providing a username and a password to add the desired gift items (Block 604). Then, the seller adds gift items which the seller wants to sell on the application using the gifting platform. The seller may provide the product details so that users who are willing to buy that item can refer to the product details and can add the item into the gift wallet (Block 606).

Thereafter, the seller lists the prices corresponding to each product. The seller can also provide the discounted prices of the listed items (Block 608). Once, the product details and prices are successfully listed on the application, the seller can start selling the gift items at the discounted price (Block 610). The users then can buy the listed items via the gift wallet software application (Block 612). It should be noted that the listed items can be added to a virtual gifting wallet, which can be shared with other users who can also purchase the item as a gift for others. For revenue generation and business purposes, the seller can pay a predefined percentage fee of each sale to the gifting platform (Block 614). For example, if the seller has sold the clothing accessories at the discounted price, then the gift wallet software application can retain a 5% fee of the sale. The percentage fee can vary based on the discounted prices of the items.

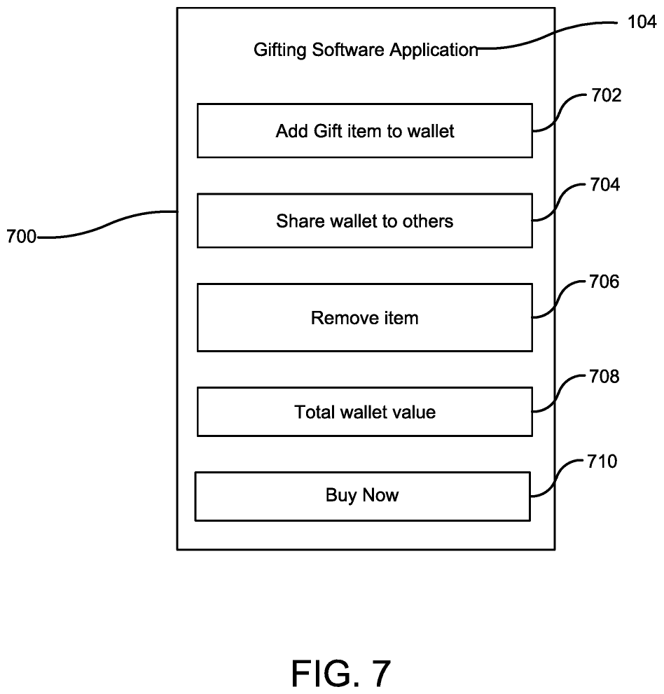

FIG. 7 illustrates an exemplary user interface 700 of the gift wallet application 104 of the present invention showing different options to a user in accordance with the disclosed architecture. The gift wallet software application 104 enables users to add selected items to their digital wallets which are provided by the application 104. The user, after selecting the desired item, can select the add gift item to the wallet option 702 to add the desired gift items to the virtual wallet. The wallet application 104 enables users to share their wallet with other users by selecting the share wallet to others option 704. This enables other authenticated users to look at the selected content/items of the virtual wallet and the items can then be purchased for gifting purposes. The wallet application 104 also provides users with a remove item option 706. The remove item option 706 enables users to remove an item from the gift wallet that was previously added.

The wallet application 104 displays the total wallet value 708 that includes a sum of the total prices of the desired gift items that the user has added within the wallet. It should be noted that a timeline can also be added with each gift item added in the wallet enabling other users to see by which date the item should be purchased for gifting. Additionally, an occasion such as a birthday, anniversary, graduation, or the like can also be tagged with the gift items. The wallet application 104 enables users to buy items in the wallet by clicking the buy now option 710. By selecting the buy now option 710, relatives or friends of the user can purchase the desired gift items.

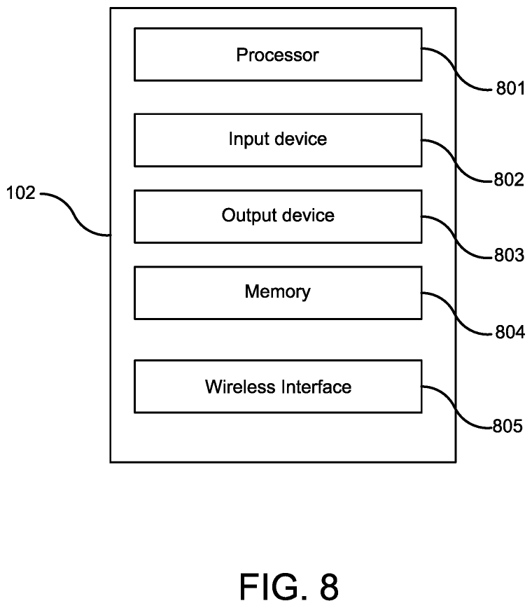

FIG. 8 illustrates an exemplary electronic device 102 in which the gifting application 104 of the present disclosure is installed in accordance with the disclosed architecture. The electronic device 102 includes several components such as a processor 801 configured to perform one or more functions described herein in accordance with the computer-implemented instructions of the application 104. The electronic device 102 includes input device(s) 802 such as a mouse, keyboard, touch input device, voice input device, etc., for entering data and information. The electronic device 102 also includes one or more output device(s) 803 such as a monitor, presence-sensitive display or other display device. The display, which can be a touch interface, acts as both an input device 802 and an output device 803. The display may be, for example, a liquid crystal display (LCD), a light emitting diode (LED) display, an organic light emitting diode (OLED) display, an active OLED (AMOLED), Micro-electromechanical systems (MEMS) display or electronic paper displays. The display screen can display, for example, various contents (e.g., text, images, videos, icons, and/or symbols, etc.) to the user. The display can include a touch screen and may receive, for example, a touch, gesture, proximity or hovering input using an electronic pen or a part of a user's body.

The electronic device 102 includes memory 804 used for storing programs (sequences of instructions) or data (e.g., program state information) on a temporary or permanent basis for use in the computer system. Memory 804 can be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art. The processor 801, in combination with one or more of memory 804, input device(s) 802 and output device(s) 803 can be utilized to enable users to execute instructions on the application 104. The connection to a network can be provided by wireless interface 805.

Certain aspects of the present disclosure are described above with reference to block and flow diagrams of systems, methods, apparatuses and/or computer program products according to various implementations. It should be understood that one or more blocks of the block diagrams and flow diagrams, and combinations of blocks in the block diagrams and the flow diagrams, respectively, can be implemented by computer-executable program instructions.

These computer-executable program instructions may be loaded onto a special-purpose computer or other particular machine, a processor, or other programmable data processing apparatus to produce a particular machine, such that the instructions that execute on the computer, processor or other programmable data processing apparatus create a means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, the computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “virtual gifting platform”, “gifting platform”, “gifting system”, “virtual gift wallet system” and “system” are interchangeable and refer to the virtual gifting platform 100 of the present invention. Similarly, as used herein “virtual gift wallet software application”, “gift wallet application”, “gifting application”, and “software application” are interchangeable and refer to the virtual gift wallet software application 104 of the present invention.

Notwithstanding the forgoing, the virtual gifting platform 100 and the virtual gift wallet software application 104 of the present invention can be of any suitable configuration as is known in the art without affecting the overall concept of the invention, provided that it accomplishes the above-stated objectives. One of ordinary skill in the art will appreciate that the configuration and specification of the components of virtual gifting platform 100 and details of the virtual gift wallet software application 104 as shown in the FIGS. are for illustrative purposes only, and that many other configurations of the virtual gifting platform 100 and the virtual gift wallet software application 104 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for providing a virtual gifting wallet to users comprising the steps of:
receiving by a server of a gifting system, a selection of a plurality of items from a list of items listed on a gifting software application, wherein said selection of said plurality of items includes descriptions and pricing information;
receiving by said server of said gifting system a request for saving said selection of said plurality of items in a virtual gifting wallet associated with a user who has made the request;
receiving by said server a sharing request to share said virtual gifting wallet and said plurality of items stored in said virtual gifting wallet with one or more other users;
sharing said items stored in said virtual gifting wallet with said one or more other users;
receiving by said server a purchase request to purchase one or more items of said plurality of items stored in said virtual gifting wallet for gifting to said user; and
tagging an occasion and a date with at least one of said selection of said plurality of items saved in said virtual gifting wallet.

2. The method of claim 1 further comprising a step of receiving by said server a profile request, wherein said profile request includes information selected from the group consisting of a name, a gender, an age, a product preference, and a store preference.

3. The method of claim 2 further comprising a step of recommending by a recommendation engine, a list of items to said user based on said profile request of said user.

4. The method of claim 3 further comprising a step of determining if one or more items stored in said virtual gifting wallet has been purchased by said user.

5. The method of claim 4 further comprising a step of notifying said user associated with said virtual gifting wallet and said one or more other users with whom said virtual gifting wallet was shared, that said one more items stored in said virtual gifting wallet has been purchased.

6. The method of claim 5 further comprising a step of comparing said profile request characteristics of said user with features of products listed and then displaying a subset of items for selecting and saving in said virtual gifting wallet.

7. The method of claim 6, wherein sharing said items stored in said virtual gifting wallet with said one or more other users includes a software application stored on a computer storage medium.

8. The method of claim 7, wherein said server in communication with a computer implemented gifting software application platform installed in an electronic device through a computer Internet network.

9. The method of claim 8 further comprising a step of offering items listed on said gifting software application platform at a discounted price and splitting a percentage of sale value with said gifting software application platform.

10. A method for providing a virtual gifting wallet to users comprising the steps of:
receiving by a server of a gifting system, a selection of a plurality of items from a list of items listed on a gifting software application, wherein said selection of said plurality of items includes descriptions and pricing information;
receiving by said server of said gifting system a request for saving said selection of said plurality of items in a virtual gifting wallet associated with a user who has made the request;
receiving by said server a sharing request to share said virtual gifting wallet and said plurality of items stored in said virtual gifting wallet with one or more other users;
sharing said items stored in said virtual gifting wallet with said one or more other users;
receiving by said server a purchase request to purchase one or more items of said plurality of items stored in said virtual gifting wallet for gifting to said user; and
notifying said user associated with said virtual gifting wallet and said one or more other users with whom said virtual gifting wallet was shared, that said one more items stored in said virtual gifting wallet has been purchased.

11. The method of claim 10 further comprising a step of receiving by said server a profile request, wherein said profile request includes information selected from the group consisting of a name, a gender, an age, a product preference, and a store preference.

12. The method of claim 11 further comprising a step of recommending by a recommendation engine, a list of items to said user based on said profile request of said user.

13. The method of claim 12 further comprising a step of determining if one or more items stored in said virtual gifting wallet has been purchased by said user.

14. The method of claim 13 further comprising a step of tagging an occasion and a date with at least one of said selection of said plurality of items saved in said virtual gifting wallet.

15. The method of claim 14 further comprising a step of comparing said profile request characteristics of said user with features of products listed and then displaying a subset of items for selecting and saving in said virtual gifting wallet.

16. The method of claim 15, wherein sharing said items stored in said virtual gifting wallet with said one or more other users includes a software application stored on a computer storage medium.

17. The method of claim 16, wherein said server in communication with a computer implemented gifting software application platform installed in an electronic device through a computer Internet network.

18. The method of claim 17, further comprising a step of offering items listed on said gifting software application platform at a discounted price and splitting a percentage of sale value with said gifting software application platform.

19. A method for providing a virtual gifting wallet to users comprising the steps of:
receiving by a server of a gifting system, a selection of a plurality of items from a list of items listed on a gifting software application, wherein said selection of said plurality of items includes descriptions and pricing information;
receiving by said server of said gifting system a request for saving said selection of said plurality of items in a virtual gifting wallet associated with a user who has made the request;
receiving by said server a sharing request to share said virtual gifting wallet and said plurality of items stored in said virtual gifting wallet with one or more other users;
sharing said items stored in said virtual gifting wallet with said one or more other users; and
receiving by said server a deposit request to deposit money into said virtual gifting wallet for gifting to said user.

20. The method of claim 19 further comprising the steps of receiving by said server a purchase request to purchase one or more items of said plurality of items stored in said virtual gifting wallet for gifting to said user; and notifying said user associated with said virtual gifting wallet and said one or more other users with whom said virtual gifting wallet was shared, that said one more items stored in said virtual gifting wallet has been purchased.
